(19) United States
(12) Patent Application Publication
(10) Pub. No.: US 2014/0172580 A1
(43) Pub. Date: Jun. 19, 2014

(54) SYSTEM AND METHOD FOR PROVIDING INFORMATION ON ADVERTISED GOODS

(71) Applicant: HYUNDAI MOTOR COMPANY, Seoul (KR)

(72) Inventors: Sung Min PARK, Seoul (KR); Seok Beom LEE, Seoul (KR); Hee Jin RO, Seoul (KR); Dong Hee SEOK, Seoul (KR)

(73) Assignee: HYUNDAI MOTOR COMPANY, Seoul (KR)

(21) Appl. No.: 13/847,827

(22) Filed: Mar. 20, 2013

(30) Foreign Application Priority Data
Dec. 14, 2012 (KR) 10-2012-0146570

(51) Int. Cl. G06Q 30/02

(52) U.S. Cl. CPC G06Q 30/0269
USPC 705/14.66

(57) ABSTRACT

A system for providing information on an advertised product includes an advertised product information processing unit for comparing a dominant frequency of the advertised product with user's eyes movement frequency, and, if the frequencies coincide with each other, determining that the user is gazing at the advertised product, extracting information on the advertised product from a storage unit and outputting the extracted information through an output unit.

### CROSS-REFERENCE TO RELATED APPLICATION

This application claims benefit of priority to Korean Patent Application No. 10-2012-0146570, filed on Dec. 14, 2012 in the Korean Intellectual Property Office, the disclosure of which is incorporated herein in its entirety by reference.

### TECHNICAL FIELD

The present disclosure relates to a system and method for providing information on advertised goods.

### BACKGROUND

Currently, advertisements of goods are being provided in various forms. For example, advertisements tailored to the broadcast program being viewed by users may be provided, or product placement (PPL), in which a specific product may be naturally exposed in a drama or various TV shows, etc., may also be used.

In the above-described PPL advertisement, a popular entertainer in the broadcast program may use the advertised product, or the product may be exposed through places frequently visited by the popular entertainer, so users may desire to obtain detailed information on the product. The users, however, have to do a cumbersome search for the information through a search on the Internet, etc. to obtain such information.

### SUMMARY

The present inventive concept has been made in view of the above problems, and an object of the present inventive concept is to provide a system and method for easily providing information on an advertised product of a product placement (PPL) advertisement to user.

An aspect of the present disclosure provides a system for providing information on an advertised product. The system includes: a communication interface unit; an advertised product frequency detection unit for converting movement information of the advertised product in a broadcast program, which is collected through the communication interface unit, into a dominant frequency of the advertised product, based on a frequency calculation criterion; a user's eyes frequency detection unit for receiving an image of a user's eyeball viewing the broadcast program from a camera through the communication interface unit, and calculating a user's eyes movement frequency based on the received image; an advertised product information processing unit for comparing the dominant frequency of the advertised product with user's eyes movement frequency, and, if the frequencies coincide with each other, determining that the user is gazing at the advertised product, extracting information on the advertised product from a storage unit and outputting the extracted information through an output unit; a storage unit for storing information related with the system as well as the information on the advertised product; and an output unit for outputting the information related with the system in one or more forms of a letter, voice and image according to a request of the advertised product information processing unit. The advertised product frequency detection unit calculates a two-dimensional (2D) moving trace from movement information of the advertised product in the broadcast program, recognizes a main moving axis direction by analyzing the calculated 2D moving trace through a principal component analysis scheme, calculates an one side direction movement path according to time by orthographically projecting the 2D moving trace in the recognized main moving axis direction, converts the movement path using a fast Fourier transformation (FFT) scheme to calculate a frequency of the largest component, and calculates a dominant frequency of the advertised product. The user's eyes frequency detection unit detects location of an eyeball from the image of the user's eyeball so as to recognize the user's eyes movement information, and converts the movement information into the user's eyes movement frequency.

Another aspect of the present disclosure encompasses a method of providing information on an advertised product in an advertised product information providing system. The method includes: converting movement information of the advertised product in a broadcast program into a dominant frequency of the advertised product based on a frequency calculation criterion by the advertised product information providing system; receiving an image of a user's eyeball viewing the broadcast program through a camera; calculating a user's eyes movement frequency based on the image of the user's eyeball; checking whether the dominant frequency of the advertised product coincides with the user's eyes movement frequency; and determining that the user is gazing at the advertised product, and extracting and outputting the information on the advertised product if the frequencies coincide with each other. The step of converting the movement information into the dominant frequency of the advertised product includes: calculating a two-dimensional (2D) moving trace from the movement information of the advertised product in the broadcast program; recognizing a main moving axis direction by analyzing the calculated 2D moving trace through a principal component analysis scheme; calculating an one side direction movement path according to time by orthographically projecting the 2D moving trace in the recognized main moving axis direction; and converting the movement path using a fast Fourier transformation (FFT) scheme to calculate a frequency of the largest component, and calculating a dominant frequency of the advertised product. The step of calculating of the user's eyes movement frequency includes: detecting an eyeball location from the image of the user's eyeball so as to recognize the user's eyes movement information; and converting the movement information into the user's eyes movement frequency. The user's eyes movement information is converted into the user's eyes movement frequency through a fast Fourier transformation scheme.

### BRIEF DESCRIPTION OF THE DRAWINGS

The objects, features and advantages of the present disclosure will be more apparent from the following detailed description in conjunction with the accompanying drawings, in which:

FIG. 1 illustrates a configuration of a system for providing information on an advertised product according to an exemplary embodiment of the present disclosure;

FIGS. 2 and 3A-3D illustrate an example of a method of outputting a frequency of an advertised product according to an exemplary embodiment of the present disclosure; and

FIG. 4 is a flowchart illustrating a method of providing information on an advertised product according to an exemplary embodiment of the present disclosure.

### DETAILED DESCRIPTION OF EXEMPLARY EMBODIMENTS

Exemplary embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

Advertised products exposed in the form of a product placement (PPL) in programs of various broadcast media (e.g., a navigation system, TV, DMB device, etc.) are used as examples of advertised products disclosed in the detailed description of the present disclosure, but the present disclosure is not limited to these examples.

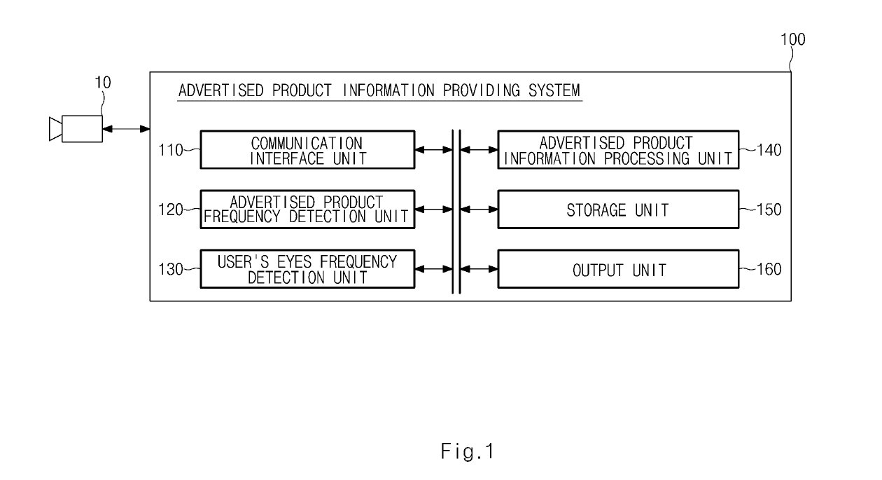

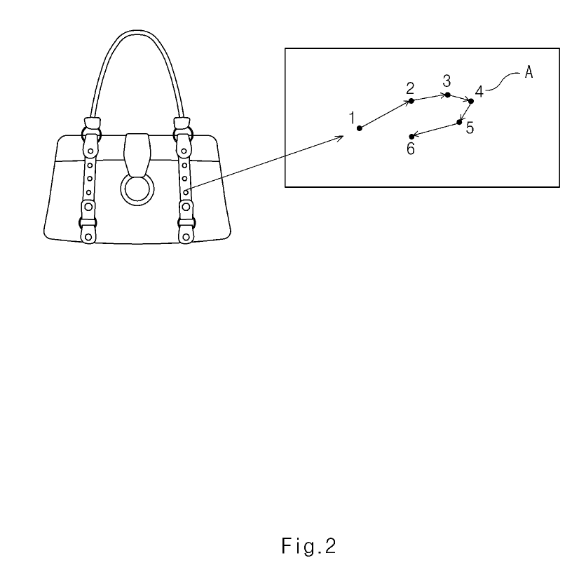

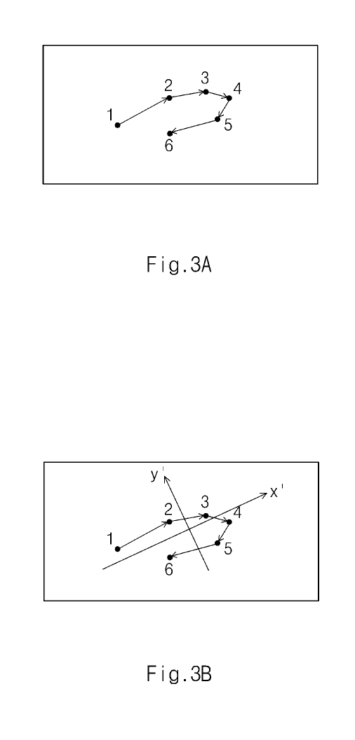

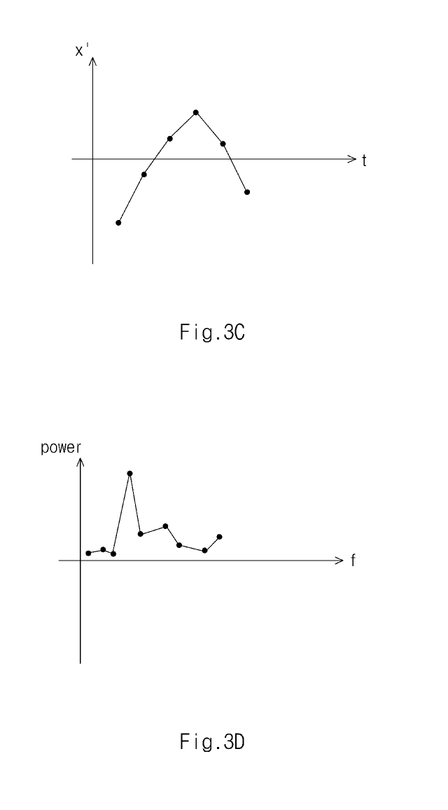

FIG. 1 illustrates a configuration of a system for providing information on an advertised product according to an exemplary embodiment of the present disclosure, and FIG. 1 will be described with reference to FIGS. 2 and 3A-3D which illustrate an example of a method of outputting a frequency of an advertised product.

As illustrated in FIG. 1, a system 100 for providing information on an advertised product may include a communication interface unit 110, an advertised product frequency detection unit 120, a user's eyes frequency detection unit 130, an advertised product information processing unit 140, a storage unit 150 and an input unit 160.

Specifically, the advertised product frequency detection unit 120 may convert the movement information of the advertised product in the broadcast program, which is collected through the communication interface unit 110, into a dominant frequency of the advertised product, based on frequency calculation criteria.

More specifically, the advertised product frequency detection unit 120 may calculate a 2D moving trace from the movement information of the advertised product in the broadcast program, recognize a main moving axis direction by analyzing the calculated 2D moving trace through the principal component analysis scheme, and calculate the path of the direction of one side according to time by orthographically projecting the 2D moving trace on the recognized main moving axis direction. The advertised product frequency detection unit further calculates the frequency of the largest component by fast Fourier transformation so as to calculate the dominant frequency of the advertised product.

For example, as illustrated in FIGS. 2 and 3, the advertised product frequency detection unit 120 recognizes the 2D moving trace by recognizing the movement information (movement in the order of 1→2→3→4→5→6) (reference numeral A of FIG. 2, and FIG. 3A) of the advertised product (e.g., a bag) of the broadcast program.

Further, as illustrated in FIG. 2, the advertised product frequency detection unit 120 analyzes the 2D moving trace (FIG. 3A) through the principal component analysis scheme so as to recognize the main moving axis direction (x′ of FIG. 3B).

At this time, the principal component analysis (PCA) scheme is one way of analyzing a data set, and according to the scheme, when the data is mapped with one axis, the axis, whose variance is the largest, becomes the first coordinate axis, and the axis, whose variance is the second largest, becomes the second coordinate axis. By sequentially performing the above process, the data is linearly converted in a new coordinate system.

Further, as illustrated in FIG. 3C, the advertised product frequency detection unit 120 calculates the moving path of the direction (x′) of one side according to time (t) by orthographically projecting the 2D moving trace in the main moving axis direction as shown in FIG. 3C, and calculates the dominant frequency of the advertised product by calculating the frequency of the largest element by fast Fourier transformation as shown in FIG. 3D.

Further, the user's eyes frequency detection unit 130 may receive the image of the user's eyeball viewing the broadcast program from the camera 100 through the communication interface unit 100, and may calculate the user's eyes movement frequency based on the image.

Specifically, the user's eyes frequency detection unit 130 may recognize the user's eyes movement information by detecting location of the eyeball from an image of the user's eyeball, and convert the movement information to a frequency of the user's eyes movement.

At this time, the user's eyes movement information may be converted into the frequency of the user's eyes movement through a fast Fourier transformation (FFT) scheme, etc.

The advertised product information processing unit 140 may compare the dominant frequency of the advertised product with the frequency of the user's eyes movement. In case the frequencies coincide with each other, it is determined that the user is gazing at the advertised product, so that information on the advertised product may be extracted from the storage unit 150, and may be outputted through the output unit 160.

The information on the advertised product may include the detailed description, price and purchasing method, etc. of the advertised product.

The storage unit 150 may store system-related information as well as the information on the advertised product.

The embodiment of the present disclosure illustrates an example of storing the information on the advertised product in the storage unit 150, but it is also possible to obtain the information from a separate advertisement server (not shown) through the communication interface unit 110 upon the request of the advertised product information processing unit 140 depending on the operator's need.

The output unit 160 may output the system-related information as well as the information on the advertised product in one or more forms of a letter, voice and image according to the request of the advertised product information processing unit 140.

At this time, the output unit 160 may output the information on the advertised product through a separate display apparatus (not shown).

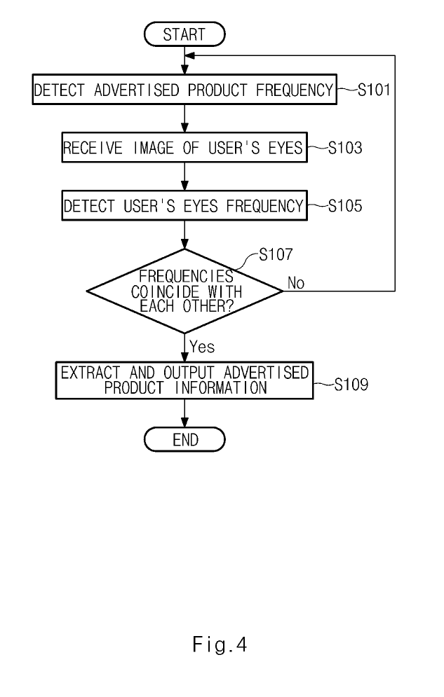

FIG. 4 is a flowchart illustrating a method of providing information on an advertised product according to an exemplary embodiment of the present disclosure, and will be described with reference to FIGS. 2 and 3 illustrating a method of outputting the frequency of the advertised product.

First, the advertised product information providing system 100 may convert the movement information of the advertised product of the broadcast program into the dominant frequency based on the frequency calculation criteria (s101).

In the step S101, first, the 2D moving trace, as illustrated in FIG. 3A, may be calculated from the movement information of the advertised product, for example the bag of FIG. 2, in the broadcast program.

Next, the main moving axis direction, e.g. x′ of FIG. 3B, may be recognized through analyzing the calculated 2D moving trace through the principal component analysis scheme.

Next, the movement path (FIG. 3C) of the direction of one side according to time may be calculated by orthographically projecting the 2D moving trace in the recognized main moving axis direction.

Next, the dominant frequency (FIG. 3D) of the advertised product may be calculated by calculating the frequency of the largest component by fast Fourier transformation of the calculated one side direction movement path.

Next, the advertised product information providing system 100 may receive the image of the user's eyeball viewing the broadcast program through the camera 10 (s103).

Next, the advertised product information providing system 100 may calculate the user's eyes movement frequency based on the image of the user's eyeball (s105).

Specifically, first, the eyeball location information may be obtained from the image of the user's eyeball so as to recognize the user's eyes movement information.

Next, the user's eyes movement information may be converted into the user's eyes movement frequency.

At this time, the user's eyes movement information may be converted into the user's eyes movement frequency through fast Fourier transformation.

Next, the advertised product information providing system 100 may check whether the dominant frequency of the advertised product coincides with the user's eyes movement frequency by comparing the frequencies (s107).

As a result of step S107, if the frequencies coincide with each other, it is determined that user is gazing at the advertised product, and thus the information of the advertised product may be extracted and outputted (s109).

As a result of step S107, if the frequencies do not coincide with each other, the advertised product information providing system 100 may perform the above process again from step S101. At this time, in case the detection of the advertised product frequency is all performed for a certain broadcast program in the initial period, the advertised product information providing system 100 may perform the above process again from step S103.

As described above, the present disclosure provides the information on the advertised product in real time depending upon whether user is gazing at the advertised product, and thus the user's convenience and the product sales of the advertisement operator may be enhanced.

According to a system and method for providing information on an advertised product of the present disclosure, the frequency of an advertised product of a product placement (PPL) advertisement exposed to a broadcast program is compared with a frequency of a user's eyes so as to extract and provide coincided information of the advertised product, and thus user's convenience is enhanced.

Further, according to the present disclosure, the information on the advertised product carefully gazed at by user is provided, and thus a user-tailored service may be provided.

Further, according to the present disclosure, user may be easily provided information on an advertised product, and thus the exposure of the information on the advertised product is extended, and thus the advertisement effects may be maximized and the sales of the advertised product may be increased.

Although exemplary embodiments of the present disclosure have been described in detail hereinabove, it should be clearly understood that many variations and modifications of the basic inventive concepts herein taught which may appear to those skilled in the present art will still fall within the spirit and scope of the present inventive concept, as defined in the appended claims.

What is claimed is:

1. A system for providing information on an advertised product, the system comprising:
a communication interface unit;
an advertised product frequency detection unit for converting movement information of the advertised product in a broadcast program, which is collected through the communication interface unit, into a dominant frequency of the advertised product, based on a frequency calculation criterion;
a user's eyes frequency detection unit for receiving an image of a user's eyeball viewing the broadcast program from a camera through the communication interface unit, and calculating a user's eyes movement frequency based on the received image;
an advertised product information processing unit for comparing the dominant frequency of the advertised product with user's eyes movement frequency, and, if the frequencies coincide with each other, determining that the user is gazing at the advertised product, extracting information on the advertised product from a storage unit and outputting the extracted information through an output unit;
a storage unit for storing information related with the system as well as the information on the advertised product; and
an output unit for outputting the information related with the system in one or more forms of a letter, voice and image according to a request of the advertised product information processing unit.

2. The system of claim 1, wherein the advertised product frequency detection unit is configured to (i) calculate a two-dimensional (2D) moving trace from movement information of the advertised product in the broadcast program, (ii) recognize a main moving axis direction by analyzing the calculated 2D moving trace through a principal component analysis scheme, (iii) calculate an one side direction movement path according to time by orthographically projecting the 2D moving trace in the recognized main moving axis direction, (iv) convert the movement path using a fast Fourier transformation (FFT) scheme to calculate a frequency of the largest component, and (v) calculate a dominant frequency of the advertised product.

3. The system of claim 1, wherein the user's eyes frequency detection unit detects an eyeball location from the image of the user's eyeball so as to recognize the user's eyes movement information, and converts the movement information into the user's eyes movement frequency.

4. A method of providing information on an advertised product in an advertised product information providing system, the method comprising:
converting movement information of the advertised product in a broadcast program into a dominant frequency of the advertised product based on a frequency calculation criterion by the advertised product information providing system;
receiving an image of a user's eyeball viewing the broadcast program through a camera;
calculating a user's eyes movement frequency based on the image of the user's eyeball;
checking whether the dominant frequency of the advertised product coincides with the user's eyes movement frequency; and
determining that the user is gazing at the advertised product, and extracting and outputting the information on the advertised product if the frequencies coincide with each other.

5. The method of claim 4, wherein the converting the movement information into the dominant frequency of the advertised product comprises:
calculating a two-dimensional (2D) moving trace from movement information of the advertised product in the broadcast program;
recognizing a main moving axis direction by analyzing the calculated 2D moving trace through a principal component analysis scheme;
calculating an one side direction movement path according to time by orthographically projecting the 2D moving trace in the recognized main moving axis direction; and
converting the movement path using a fast Fourier transformation (FFT) scheme to calculate a frequency of the largest component, and calculating a dominant frequency of the advertised product.

6. The method of claim 4, wherein the calculating of the user's eyes movement frequency comprises:
detecting an eyeball location from the image of the user's eyeball so as to recognize the user's eyes movement information; and
converting the movement information into the user's eyes movement frequency.

7. The method of claim 6, wherein the user's eyes movement information is converted into the user's eyes movement frequency through a FFT scheme.
